(19) United States
(12) Patent Application Publication
(10) Pub. No.: US 2021/0156344 A1
(43) Pub. Date: May 27, 2021

(54) CONTROL APPARATUS AND METHOD FOR PREVENTING BOILING OF EGR COOLER

(71) Applicants: HYUNDAI MOTOR COMPANY, Seoul (KR); KIA MOTORS CORPORATION, Seoul (KR)

(72) Inventor: Han Sang Kim, Ansan-si (KR)

(21) Appl. No.: 16/898,876

(22) Filed: Jun. 11, 2020

(30) Foreign Application Priority Data
Nov. 26, 2019 (KR) 10-2019-0153070

(51) Int. Cl. F02M 26/28; F02M 26/05

(52) U.S. Cl. CPC F02M 26/28; F02M 26/33; F02M 26/05

(57) ABSTRACT

The present disclosure relates to a control apparatus and method for preventing boiling of an exhaust gas recirculation (EGR) cooler, the apparatus including a coolant inflow passage configured to allow coolant to flow into the EGR cooler, a coolant discharge passage having one end connected to the EGR cooler to allow the coolant cooling EGR gas to be discharged, an EGR valve positioned adjacent to the EGR cooler to control a flow rate of gas flowing into the engine, and a control unit configured to determine the flow rate of the coolant flowing into the EGR cooler according to a number of revolutions of the engine, determine an opening amount of the EGR valve, determine whether the EGR cooler is in a micro-boiling condition, and perform compensation to perform boiling prevention when the EGR cooler satisfies the micro-boiling condition.

### CROSS REFERENCE TO RELATED APPLICATIONS

The present application claims priority to Korean Patent Application No. 10-2019-0153070, filed Nov. 26, 2019, the entire contents of which is incorporated herein for all purposes by this reference.

### BACKGROUND

### Field

The present disclosure relates to a control apparatus and method for preventing boiling of an EGR cooler and, more preferably, to a control apparatus and method for preventing boiling of an EGR cooler, by which the flow rate of the gas flowing into the EGR or the flow rate of the coolant into the EGR cooler is controlled corresponding to the micro-boiling conditions of the coolant located inside the EGR cooler, thereby preventing boiling of the coolant located inside the EGR cooler.

### Description of the Related Art

In general, exhaust gas recirculation (EGR) performs a function of reducing the temperature of a combustion chamber by inhaling a portion of the exhaust gas of the vehicle, thereby reducing the emission of harmful substances such as nitrogen oxides and sulfur oxides.

In addition, the EGR cooler is now applied together to lower the temperature of the EGR gas as global regulations on air pollution are tightened.

The exhaust gas flowing into the EGR cooler cools the EGR gas by the coolant discharged through the engine.

Furthermore, when the temperature of the coolant is equal to or higher than the predetermined temperature and the temperature of the coolant flowing into the EGR cooler is equal to or higher than the boiling condition, it is controlled to block the driving of the EGR.

In addition, as the coolant inside the EGR cooler is lost due to boiling, there is a problem that the engine is overheated due to a lack of the coolant. Furthermore, as the coolant is lost due to boiling, the coolant should be replenished frequently, whereby there is a problem that the cost of replenishing the coolant is increased.

In addition, the flow rate of the coolant flowing into the EGR cooler and the flow rate of the coolant circulating in the engine, heater, EGR cooler, and radiator cannot be controlled in the related art, there is a problem that the cooling efficiency of the EGR cooler is reduced and finally the efficiency of the engine is reduced.

### SUMMARY

The present disclosure has been made keeping in mind the above problems occurring in the related art, and an object of the present disclosure is to provide a control apparatus and method for preventing boiling of an EGR cooler, which mitigates the boiling conditions of the coolant located inside the EGR cooler and thus extend the EGR operating conditions.

An object of the present disclosure is to provide a control apparatus and method for preventing boiling of an EGR cooler, in which an opening amount of the EGR valve or a flow rate of coolant flowing into the EM cooler is controlled in correspondence with micro-conditions of the coolant located inside the EGR cooler.

The objects of the present disclosure are not limited to the above-mentioned objects, and other objects of the present disclosure which are not mentioned can be understood by the following description and can be more clearly understood by the embodiments of the present disclosure. Further, the objects of the present disclosure can be realized by the means shown in the claims and their combinations.

In order to achieve the above objects, the control apparatus and method for preventing boiling of an EGR cooler includes configurations following.

According to an embodiment, a control apparatus for preventing boiling of an exhaust gas recirculation (EGR) cooler includes a coolant inflow passage configured to allow coolant to flow into the EGR cooler, a coolant discharge passage having one end connected to the EGR cooler to allow the coolant cooling EGR gas to be discharged, an EGR valve positioned adjacent to the EGR cooler to control a flow rate of gas flowing into an engine, and a control unit configured to determine a flow rate of the coolant flowing into the EGR cooler according to a number of revolutions of the engine, determine an opening amount of the EGR valve, determine whether the EGR cooler is in a micro-boiling condition, and perform compensation to perform boiling prevention when the EGR cooler satisfies the micro-boiling condition.

In addition, the control apparatus for preventing boiling of the EGR cooler may further include a coolant flow rate controller configured to control the flow rate of the coolant flowing into the EGR cooler and located in the coolant inflow passage.

In addition, the control unit may be configured to control the coolant flow rate controller so that the flow rate of the coolant flowing into the EGR cooler is increased in the micro-boiling condition of the EGR cooler.

In addition, the control unit may be configured to control the EGR valve so that the flow rate of the EGR gas is reduced, when the coolant flow rate flowing into the EGR cooler is not increased through the coolant flow rate controller.

In addition, the control unit may be configured to control the EGR valve so that the flow rate of the EGR gas is reduced in the micro-boiling conditions of the EGR cooler.

In addition, according to another of the present disclosure, a control method for preventing boiling of an exhaust gas recirculation (EGR) cooler includes determining whether a coolant temperature measured by a control unit is equal to or greater than a predetermined value, determining a flow rate of EGR gas according to a number of revolutions and a load of an engine through the control unit, when the coolant temperature is greater than or equal to the predetermined value, determining a flow rate of coolant flowing into the EGR cooler in response to the number of revolutions of the engine through the control unit, determining whether the coolant flowing into the EGR cooler is in a micro-boiling condition, and performing compensation to perform boiling prevention by the control unit, when the coolant is determined to be in the micro-boiling condition by the control unit.

In addition, the determining of the coolant flow rate flowing into the EGR cooler in response to the number of revolutions of the engine through the control unit may include determining the coolant flow rate flowing into the EGR cooler through the coolant flow rate controller and the number of revolutions of the engine.

In addition, the performing the compensation to perform the boiling prevention by the control unit when the coolant is determined to be in the micro-boiling condition may include performing control to increase the flow rate of the coolant flowing into the EGR cooler by the control unit.

In addition, the performing control to increase the flow rate of the coolant flowing into the EGR cooler by the control unit may include determining whether the flow rate of the coolant flowing into the EGR cooler is increased; and reducing the flow rate of the EGR gas, when the flow rate of the coolant flowing into the EGR cooler is not increased.

In addition, the reducing of the flow rate of the EGR gas may include controlling an opening amount of the EGR valve to reduce the flow rate of the EGR gas flowing into the EGR cooler.

In addition, the performing the compensation to perform the boiling prevention by the control unit when the coolant is determined to be in the micro-boiling condition may include performing control to reduce the flow rate of the EGR gas by the control unit.

In addition, the micro-boiling condition may be determined for a region in which the flow rate of the coolant flowing into the EGR cooler increases linearly as the flow rate of the gas is increased.

The present disclosure can obtain the following effects according to the above-described embodiment, the constitution described below, and the combination and use relationship.

The present disclosure has the effect of further extending the driving conditions of the EGR by compensating conditions of the flow rate of the gas and the flow rate of the flowing coolant in response to temperature conditions of the coolant inside the EGR cooler.

In addition, the present disclosure provides an effect of increasing the engine driving efficiency by extending the EGR driving conditions.

### BRIEF DESCRIPTION OF THE FIGURES

The above and other objects, features and other advantages of the present disclosure will be more clearly understood from the following detailed description when taken in conjunction with the accompanying drawings, in which:

FIG. 1 is a block diagram illustrating a coupling relationship between components of a control apparatus for preventing boiling of an EGR cooler according to an embodiment of the present disclosure;

FIG. 2 is a block diagram illustrating a coupling relationship between components of a control apparatus for preventing boiling of an EGR cooler according to another embodiment of the present disclosure;

FIG. 3 is a flowchart illustrating a control method for preventing boiling of an EGR cooler that does not include a coolant flow rate controller according to an embodiment of the present disclosure;

FIG. 4 is a graph illustrating compensation performed over boiling intervals by controlling a gas flow rate according to an embodiment of the present disclosure;

FIG. 5 is a flowchart illustrating a control method for preventing boiling of an EGR cooler including a coolant flow rate controller according to another embodiment of the present disclosure; and

FIG. 6 is a graph illustrating compensation performed over boiling intervals by controlling the gas flow rate and the flow rate of coolant flowing into an EGR cooler according to another embodiment of the present disclosure.

### DETAILED DESCRIPTION

Hereinafter, embodiments of the present disclosure will be described in detail with reference to the accompanying drawings. The embodiments of the present disclosure can be modified in various forms, and the scope of the present disclosure should not be construed as being limited to the following embodiments. This embodiment is provided to more fully explain the present disclosure to those skilled in the art.

Also, the terms “part”, “unit”, “module”, and the like, which are described in the specification, mean a unit for processing at least one function or operation, which can be implemented as hardware, software, or a combination of hardware and software.

In addition, “micro-boiling” described in the specification means a condition that boiling of the coolant inside an EGR cooler 110 begins according to the coolant temperature, the gas flow rate, the coolant flow rate inside the EGR cooler 110, in which a micro-boiling region and a boiling region may be substantially interpreted to be the same sense.

The present disclosure relates to a control apparatus and method for preventing boiling of the coolant flowing into the EGR cooler 110, and provides a technique for expanding the operating conditions of the EGR cooler 110 and increasing the driving efficiency of an engine 200.

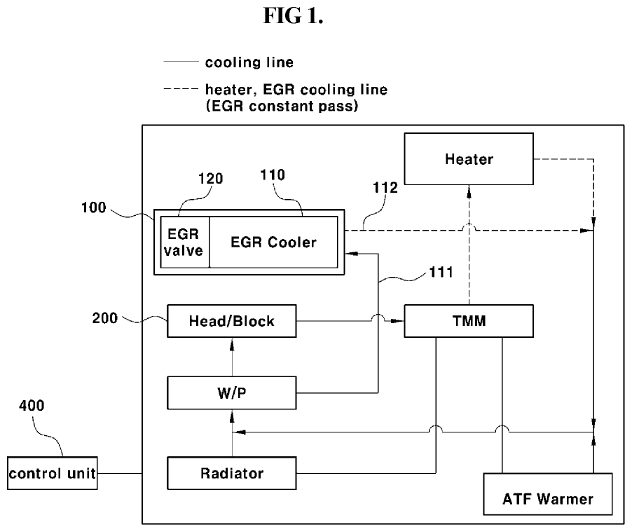

FIG. 1 is a view illustrating a control apparatus for preventing boiling in an EGR cooler 110 included in an EGR system 100 according to an embodiment of the present disclosure.

The EGR system 100 is configured to control an opening amount of an EGR valve so that the exhaust gas of the engine 200 flows in. The EGR system 100 includes an EGR cooler 110 to cool the high temperature exhaust gas. Furthermore, the EGR valve for controlling the gas flow rate flowing into the EGR system 100 is provided to be located at one end of the EGR cooler 110 or adjacent to the EGR cooler 110 and is controlled through a control unit 400 of the vehicle.

The coolant is provided to flow into the EGR cooler 110 along the inflow passage 111 branched from the inlet of the cooler line entered into the engine 200.

Alternatively, the coolant discharged after cooling the engine 200 may be introduced into the EGR cooler 110 through the inflow passage 111.

According to an embodiment of the present disclosure, referring to FIG. 1, a control apparatus for preventing boiling of an EGR cooler is configured so that the EGR cooler 110 maintains an open state at all times to allow the coolant to flow inside the EGR cooler 110 in proportion to the number of revolutions of the engine 200.

The control apparatus is configured so that the coolant introduced into the EGR cooler 110 performs cooling of the gas passing through the EGR system 100 to be circulated through a discharge passage 112. Then, the control apparatus is configured so that the discharged coolant is cooled through a radiator and then introduced into the engine 200, thereby being introduced again into the EGR cooler 110.

The control unit 400 includes a water temperature sensor (WTS) that measures the temperature of the coolant. Considering the temperature of the coolant flowing into the EGR cooler 110, the control unit 400 is provided to determine the boiling condition of the coolant inside the EGR cooler 110.

More preferably, at least one or more sensors may be located at the front end of the EGR cooler 110 or at one end adjacent to the inlet of the engine 200.

In addition, the control unit 400 determines the flow rate of coolant flowing into the EGR cooler 110 according to the number of revolutions of the engine 200, in which the flow rate of coolant may be set on the basis of map values stored through an engine management system (EMS).

According to an embodiment of the present disclosure, the control unit 400 determines whether the temperature of the coolant is greater than or equal to the predetermined temperature, and when it is determined that the temperature of the coolant is greater than or equal to the predetermined temperature, the flow rate of the gas flowing into the EGR system 100 and the flow rate of the coolant flowing into the EGR cooler 110 are determined.

More preferably, the control unit 400 is provided so that the flow rate of the gas is set according to the revolution number and load of the engine 200 and the flow rate of the coolant flowing into the EGR cooler 110 is also determined, on the basis of the map values stored in the control unit 400.

The boiling condition of the coolant inside the EGR cooler 110 is determined on the basis of gas flow rate and the coolant flow determined as described above.

The control unit 400 may reduce the flow rate of the gas flowing inside the EGR system 100 by controlling the opening amount of the EGR valve, when the micro-boiling condition of the coolant positioned inside the EGR cooler 110 is satisfied.

The EGR system 100 having a reduced gas flow rate is driven under non-boiling conditions, and accordingly driving environmental conditions of the EGR system 100 are provided to be mitigated.

Referring to FIG. 1, according to an embodiment of the present disclosure, boiling prevention compensation is performed for the engine 200 and the EGR cooler 110 configured to allow the coolant to pass through at all times. More preferably, the EGR valve is provided to be controlled according to micro-boiling conditions on the basis of the gas flow rate and the coolant flow rate in the EGR cooler 110.

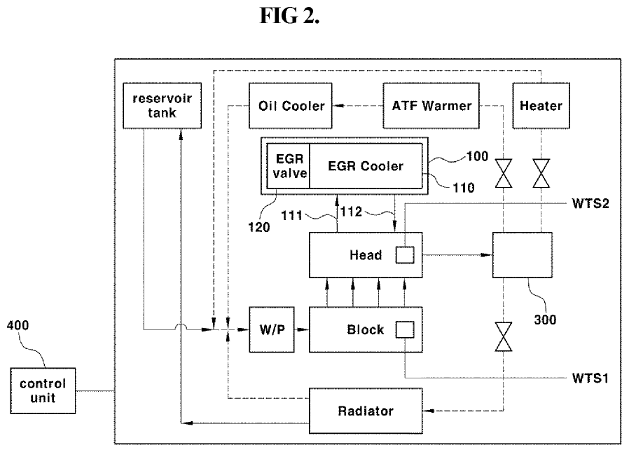

FIG. 2 is a block diagram illustrating a control apparatus for preventing boiling of an EGR cooler 110 with a coolant flow rate controller 300 that controls the flow rate of the coolant flowing into the EGR cooler 110 as compared to FIG. 1.

In FIG. 2, the coupling relationship in the control apparatus including the coolant flow rate controller 300 that controls the flow rate of the coolant flowing into the EGR cooler 110 is illustrated.

As shown, the coolant located in the reservoir tank is pressurized through the water pump, and the pressurized coolant may be controlled to distribute the coolant by the coolant flow rate controller 300.

More preferably, the flow rate of the coolant flowing into the EGR cooler 110 positioned adjacent to the engine 200 may be controlled by the coolant flow rate controller 300.

The control unit 400 is configured to control the opening amount of the EGR valve in response to the coolant temperature and the micro-boiling condition of the coolant inside the EGR cooler 110. Furthermore, the flow rate of the coolant flowing into the EGR cooler 110 is controlled so that the EGR system 100 may be controlled in the non-boiling conditions.

That is, the control unit 400 determines whether the coolant temperature is equal to or greater than a predetermined temperature, sets the flow rate of the gas according to the revolution number and the load of the engine 200, and determines the flow rate of the coolant flowing into the EGR cooler 110. In addition, the control unit determines the micro-boiling conditions inside the EGR cooler 110.

More preferably, the gas flow rate and the flow rate of the coolant flowing into the EGR cooler 110 may be selected by map values stored in the control unit 400 according to the revolution number and the load of the engine.

When the micro-boiling condition is satisfied inside the EGR cooler 110, the control unit 400 performs control to increase the flow rate of the coolant flowing into the EGR cooler 110 through the coolant flow rate controller 300. When it is determined that the flow rate of the coolant flowing into the EGR cooler 110 is not increased, the flow rate of the gas flowing into the EGR system 100 is further controlled to be reduced by controlling the opening amount of the EGR valve.

The compensation control operation of increasing the coolant flow rate may not be performed, when the coolant is inclined to one side according to the climbing condition of the vehicle. Therefore, during the above driving condition, the coolant flowing into the EGR cooler 110 cannot be increased. Accordingly, the control unit 400 performs control to increase the flow rate of the coolant flowing into the EGR cooler 110, and then determines whether the flow rate of the coolant inside the EGR cooler 110 is increased.

When the control unit 400 does not perform control to increase the flow rate of the coolant flowing into the EGR cooler 110, the control unit 400 performs control to further reduce the flow rate of the gas flowing into the EGR system 100 so that the coolant inside the EGR cooler 110 may not be boiled.

According to another embodiment of the present disclosure, when the micro-boiling conditions of the EGR cooler 110 are satisfied, the coolant flow rate controller 300 is provided so that the flow rate of the coolant flowing into the EGR cooler 110 is increased in advance and the gas flowing in the EGR system 100 is reduced under the condition that the flow rate of the coolant is not increased.

As described above, FIG. 1 illustrates a constant pass structure in which the coolant passes through the EGR cooler 110 at all times according to an embodiment of the present disclosure, whereas FIG. 2 illustrates a structure in which the flow rate of the coolant flowing into the EGR cooler 110 is controlled through the coolant flow rate controller 300 according to another embodiment of the present disclosure. Accordingly, it will be appreciated that the compensation is differently performed according to micro-boiling conditions.

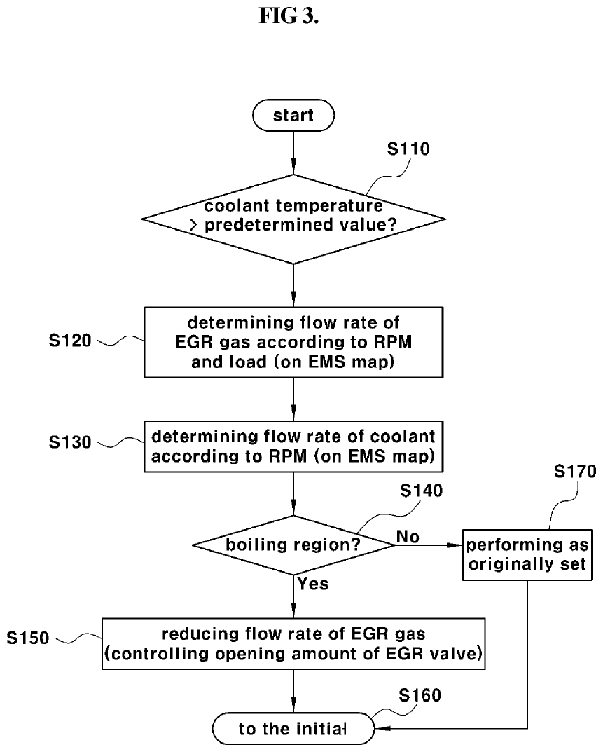

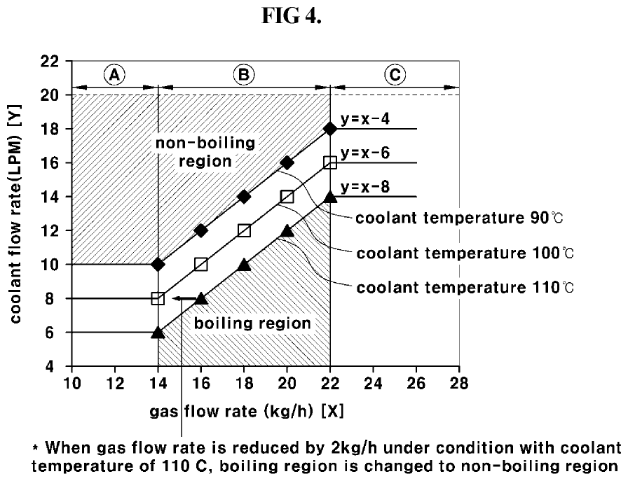

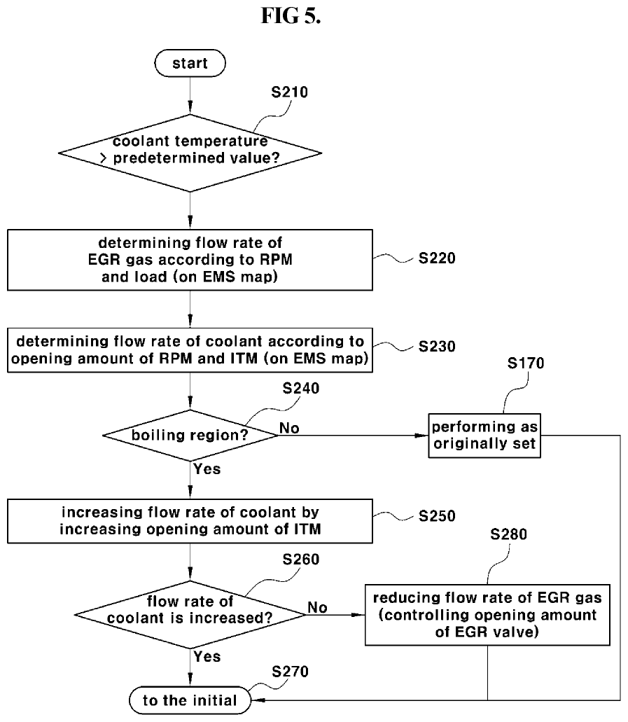

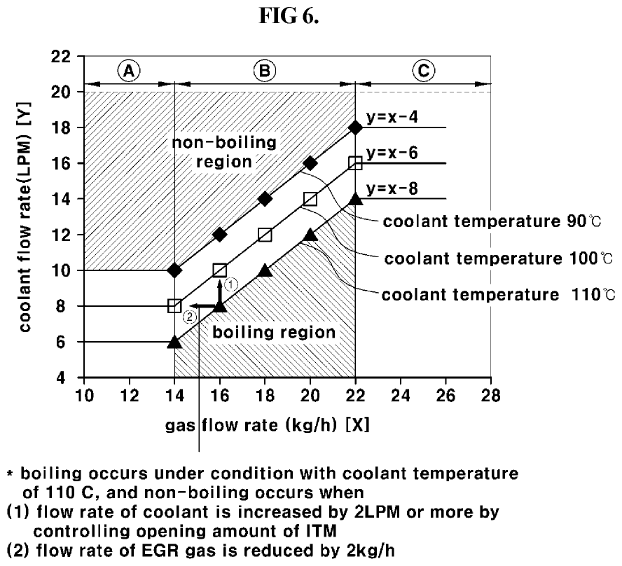

FIGS. 3 and 4 illustrate a control method for preventing boiling of an EGR cooler 110 and a driving point graph of the EGR system 100 compensated in non-boiling conditions according to the constant pass structure. Meanwhile, FIGS. 5 and 6 illustrate a control method for preventing boiling of an EGR cooler 110 and a driving point graph of the EGR cooler 110 compensated in anti-boiling conditions in a system including a coolant flow rate controller 300.

FIG. 3 is a flowchart illustrating a control method for preventing boiling of the EGR cooler 110 in the EGR system 100 in which the coolant passes through the EGR cooler 110 at all times.

As shown, the control unit 400 includes a step of measuring a temperature of the coolant flowing into the vehicle cooling system through a temperature sensor located in a cooling system of the vehicle, and determining whether or not the temperature is equal to or greater than a predetermined temperature (S110).

When the coolant temperature is less than the predetermined temperature, the logic is terminated. When the coolant temperature exceeds the predetermined temperature, the flow rate of the gas flowing into the EGR system 100 is determined according to the number of revolutions of the engine 200 and the load of the engine 200 (S120).

The gas flowing into the EGR system 100 may be selected using map values stored in an engine management system (EMS).

Furthermore, the coolant flow rate flowing through the inflow passage 111 of the EGR cooler 110 is set, in which the coolant flow rate may be determined through map values stored in an engine management system (EMS) of the control unit 400 (S130).

Thereafter, it is determined whether the coolant inside the EGR cooler 110 satisfies the condition of the micro-boiling region (S140).

When the coolant flowing inside the EGR cooler 110 corresponds to the boiling region, the control unit 400 controls the opening amount of the EGR valve so that the flow rate of the gas flowing inside the EGR system 100 is reduced by 2 Kg/h (S150), and then the process returns to the initial step (S160).

However, when the coolant inside the EGR cooler 110 is not in the micro-boiling region (S140), the coolant flow rate of the EGR cooler 110 and the opening amount of the EGR valve are maintained as originally set (S170), and then the process returns to the initial step (S150).

Referring to FIG. 4, when the compensation control of reducing the opening amount of the EGR valve of FIG. 3 is performed, the EGR cooler 110 is compensated by changing an EGR driving point from the micro-boiling region to the non-boiling region.

As shown, the flow rate of the gas flowing into the EGR system 100 is shown on the X axis, and the EGR coolant flow rate is shown on the Y axis, in which the boiling and non-boiling regions are graphically shown through the relationship between the two factors.

In addition, it is configured to have a micro-boiling point at different positions according to the coolant temperature, it can be seen that, under the same gas flow rate condition, the higher coolant temperature measured, the lower coolant flow rate in the micro-boiling region.

The control unit 400 of the present disclosure is configured to perform boiling prevention control in a region in which the coolant flow rate increases linearly in response to the increased value of the gas flow rate.

That is, the control unit is provided to perform compensation control to prevent boiling in a region in which the coolant flow rate increases linearly with the increase of the gas flow rate.

When performing compensation to reduce the gas flowing in the EGR system 100, the compensation is performed so that the driving point of the EGR cooler 110 is changed from the micro-boiling region to the non-boiling region.

More preferably, as an embodiment of the present disclosure, the control apparatus for preventing boiling of the EGR cooler 110 having the constant pass structure for the coolant circulation has micro-boiling conditions wherein the measured coolant temperature is 110° C., the gas flow rate is 16 kg/h, and the coolant flow rate is 8 LPM.

Under the same conditions, when the flow rate of the gas flowing into the EGR system 100 is reduced by 2 kg/h according to the boiling prevention compensation, the driving point of the EGR cooler 110 may be moved from the boiling region to the non-boiling region (driving point having gas flow rate of 14 kg/h and coolant flow rate of 8 LPM). That is, the control unit 400 is provided to perform boiling prevention compensation by reducing the flow rate of gas flowing into the EGR system 100.

FIG. 5 is a flowchart illustrating a control method for compensating boiling through the control apparatus for preventing boiling of the EGR cooler 110 including the coolant flow rate controller 300.

As shown, the control unit 400 includes a step of measuring a temperature of the coolant flowing into a cooling system of the vehicle through a temperature sensor located in the cooling system, and determining whether or not the temperature is equal to or greater than the predetermined temperature (S210).

When the coolant temperature exceeds the predetermined temperature, the flow rate of the gas flowing into the EGR system 100 is determined according to the number of revolutions of the engine 200 and the load of the engine 200 (S220).

Preferably, the flow rate of the gas flowing into the EGR system 100 may be determined according to map values stored in the control unit 400. In another embodiment of the present disclosure, the gas flow rate flowing into the EGR system 100 may be determined using map values stored through an engine management system (EMS).

Further, the coolant flow rate flowing through the coolant inflow passage 111 of the EGR cooler 110 may be determined, and more specifically, the coolant flow rate may be determined through the map values stored in the control unit 400 (S230).

More preferably, the coolant flow rate flowing into the EGR cooler 110 may be set using map values of an engine management system (EMS), and more specifically, the coolant flow rate may be set through the number of revolutions of the engine 200 of the vehicle and the opening amount of coolant flow rate controller 300.

Thereafter, it is determined whether the coolant inside the EGR cooler 110 is in a micro-boiling region (S240).

When the coolant flowing inside the EGR cooler 110 is in the boiling region, the flow rate of the coolant flowing into the EGR cooler 110 is increased by increasing the opening amount of the coolant flow rate controller 300 (S250), and it is determined whether the coolant flow rate is increased (S260).

More preferably, when performing compensation of increasing the flow rate of the coolant flowing into the EGR cooler 110, the coolant flow rate may be controlled to be increased by 2 LPM, compared to the coolant flow rate driven before compensation (S250).

When it is determined that the coolant flow rate flowing into the EGR cooler 110 is increased by a predetermined increase amount through compensation of increasing the opening amount of the coolant flow rate controller 300, the process returns to the initial step (S270). However, when it is determined that the coolant flow rate is not increased by the predetermined increase amount, the flow rate of the gas flowing into the EGR system 100 is controlled to be reduced (S280).

More preferably, in the step of performing compensation of reducing the flow rate of the gas, the opening amount of the EGR valve is controlled to reduce the flow rate of the gas flowing in the EGR system 100 by 2 Kg/h (S280), and then the process returns to the initial step (S270).

However, when the coolant inside the EGR cooler 110 is not in the micro-boiling region (S240), the coolant flow rate of the EGR cooler 110 and the opening amount of the EGR valve are maintained as originally set (290), and then the process returns to the initial step (S270).

FIG. 6 is a graph illustrating a result of performing a control method for preventing boiling of an EGR cooler 110 including a coolant flow rate controller.

In the graph of FIG. 6, the same factors as in FIG. 4 are included. That is, the flow rate of the gas flowing into the EGR system 100 is shown on the X axis, and the EGR coolant flow rate is shown on the Y axis, in which the relationship between the two factors is graphically shown.

The control unit 400 of the present disclosure is configured to perform boiling prevention control in a region in which the coolant flow rate increases linearly in response to the increase value of the gas flow rate. Furthermore, the boiling prevention compensation is performed in advance through the coolant flow rate controller 300, and thus the coolant flow rate flowing into the EGR cooler 110 may be controlled to be increased.

When the coolant flow rate flowing into the EGR cooler 110 is increased, the compensation is performed so that the driving point of the EGR cooler 110 located in the micro-boiling line is moved to the non-boiling region.

In addition, since it is difficult to increase the coolant flow rate flowing into the EGR cooler 110, when the coolant is concentrated to one end of the vehicle due to a driving condition of the vehicle, the control unit 400 performs the coolant flow increase control and then determines whether the coolant flow rate actually flowing inside the EGR cooler 110 is increased by a predetermined increase amount.

However, when the control for increasing the coolant flow rate inside the EGR cooler 110 through the control unit 400 is not performed according to the above conditions, the flow rate of the gas flowing inside the EGR system 100 is reduced by reducing the opening amount of the EGR valve.

More preferably, as another embodiment of the present disclosure, a coolant circulation structure including a coolant flow rate controller 300 is provided, and the control apparatus for preventing boiling of the EGR cooler 110 has micro-boiling conditions wherein the gas flow rate is 16 kg/h, the coolant temperature is 110° C., and the coolant flow rate is 8 LPM.

When the coolant flow rate flowing into the EGR cooler 110 is controlled according to the boiling prevention compensation under the same conditions as the foregoing, the coolant flow rate is controlled to change from the first 8 LPM to 10 LPM.

Then, the control unit 400 determines whether the coolant flow rate is increased to 10 LPM, and when the coolant flow rate is not compensated to 10 LPM, the control unit 400 performs control to reduce the gas flowing into the EGR system 100 by 2 Kg/h.

In the case of performing the above control, the driving point of the EGR cooler 110 may be moved from the boiling region to the non-boiling region on the graph shown. Furthermore, when the coolant flow control is performed, the driving point of the EGR cooler 110 is controlled to move upwards with respect to the Y-axis, and when coolant flow control is not performed, the gas flow control flowing into the EGR system 100 is performed so that the driving point is controlled to move to the left with respect to the X axis.

Accordingly, the driving points of the EGR cooler 110 are all moved to the non-boiling region according to the control described above.

That is, the control unit 400 controls the coolant flow rate flowing into the EGR cooler 110 in advance through another embodiment of the present disclosure, and then additionally performs reduction compensation of gas flowing into the EGR system 100 under the condition that the coolant control is not performed, thereby performing boiling prevention compensation of the EGR cooler 110.

As described, the present disclosure provides a control apparatus and method for preventing boiling of the EGR cooler 110, which enables driving the EGR system 100 in the micro-boiling region of the coolant.

The foregoing detailed description illustrates the present disclosure. Furthermore, the foregoing is intended to illustrate and explain the preferred embodiments of the present disclosure, and the present disclosure may be used in various other combinations, modifications, and environments. That is, it is possible to make changes or modifications within the scope of the concept of the disclosure disclosed in the present specification, equivalents to the disclosure and/or the scope of the art or knowledge of the present disclosure. The described embodiments are intended to be illustrative of the best mode for carrying out the technical idea of the present disclosure and various changes may be made in the specific applications and uses of the present disclosure. Therefore, the detailed description of the disclosure is not intended to limit the disclosure to the disclosed embodiments. It is also to be understood that the appended claims are intended to cover further embodiments.

1. A control apparatus for preventing boiling of an exhaust gas recirculation (EGR) cooler, the apparatus comprising:
a coolant inflow passage configured to allow coolant to flow into the EGR cooler;
a coolant discharge passage having one end connected to the EGR cooler to allow the coolant cooling EGR gas to be discharged;
an EGR valve positioned adjacent to the EGR cooler to control a flow rate of gas flowing into an engine; and
a control unit configured to determine a flow rate of the coolant flowing into the EGR cooler according to a number of revolutions of the engine, determine an opening amount of the EGR valve, determine whether the EGR cooler is in a micro-boiling condition, and perform compensation to perform boiling prevention when the EGR cooler satisfies the micro-boiling condition.

2. The apparatus of claim 1, further comprising:
a coolant flow rate controller configured to control the flow rate of the coolant flowing into the EGR cooler and located in the coolant inflow passage.

3. The apparatus of claim 2, wherein the control unit is configured to control the coolant flow rate controller so that the flow rate of the coolant flowing into the EGR cooler is increased in the micro-boiling condition of the EGR cooler.

4. The apparatus of claim 3, wherein the control unit is configured to control the EGR valve so that the flow rate of the EGR gas is reduced, when the coolant flow rate flowing into the EGR cooler is not increased through the coolant flow rate controller.

5. The apparatus of claim 1, wherein the control unit is configured to control the EGR valve so that the flow rate of the EGR gas is reduced in the micro-boiling conditions of the EGR cooler.

6. A control method for preventing boiling of an exhaust gas recirculation (EGR) cooler, the method comprising:
determining whether a coolant temperature measured by a control unit is equal to or greater than a predetermined value;
determining a flow rate of EGR gas according to a number of revolutions and a load of an engine through the control unit, when the coolant temperature is greater than or equal to the predetermined value;
determining a flow rate of coolant flowing into the EGR cooler in response to the number of revolutions of the engine through the control unit;
determining whether the coolant flowing into the EGR cooler is in a micro-boiling condition; and
performing compensation to perform boiling prevention by the control unit, when the coolant is determined to be in the micro-boiling condition by the control unit.

7. The method of claim 6, wherein the determining of the coolant flow rate flowing into the EGR cooler in response to the number of revolutions of the engine through the control unit includes:
determining the coolant flow rate flowing into the EGR cooler through the coolant flow rate controller and the number of revolutions of the engine.

8. The method of claim 6, wherein the performing the compensation to perform the boiling prevention by the control unit when the coolant is determined to be in the micro-boiling condition includes:
performing control to increase the flow rate of the coolant flowing into the EGR cooler by the control unit.

9. The method of claim 8, wherein the performing control to increase the flow rate of the coolant flowing into the EGR cooler by the control unit includes:
determining whether the flow rate of the coolant flowing into the EGR cooler is increased; and
reducing the flow rate of the EGR gas, when the flow rate of the coolant flowing into the EGR cooler is not increased.

10. The method of claim 9, wherein the reducing of the flow rate of the EGR gas includes:
controlling an opening amount of the EGR valve to reduce the flow rate of the EGR gas flowing into the EGR cooler.

11. The method of claim 6, wherein the performing the compensation to perform the boiling prevention by the control unit when the coolant is determined to be in the micro-boiling condition includes:
performing control to reduce the flow rate of the EGR gas by the control unit.

12. The method of claim 6, wherein the micro-boiling condition is determined for a region in which the flow rate of the coolant flowing into the EGR cooler increases linearly as the flow rate of the gas is increased.
